(19) United States
(12) Patent Application Publication
(10) Pub. No.: US 2010/0123319 A1
(43) Pub. Date: May 20, 2010

(54) MECHANICALLY-DRIVEN ELECTRIC GENERATOR

(76) Inventor: Christopher J. Cali, Little Falls, NJ (US)

Correspondence Address: KRAMER & AMADO, P.C., 1725 DUKE STREET, SUITE 240, ALEXANDRIA, VA, 22314, US

(21) Appl. No.: 12/270,899

(22) Filed: Nov. 14, 2008

(51) Int. Cl. H02K 7/18

(52) U.S. Cl. 290/1 A; 290/1 C

(57) ABSTRACT

A generator produces electrical energy by extracting potential energy from the vertical movement of weights. A tandem system converts this vertical movement into rotational energy in pulleys coupled to the weights. A pulley belt system then transfers this energy and uses gear ratios to increase the rotational speed. A gearbox system then uses the kinetic energy provided at increased rotational speed to generate electrical energy.

### BACKGROUND

1. Technical Field

This invention relates generally to production of electric power, and more particularly to conversion of potential energy into electric power.

2. Description of Related Art

Generation of electrical energy is a well known and established field. Much research has focused on applications where a rotating shaft drives a generator system in order to produce electrical energy. Various types of energy may be used to rotate the shaft, such as tidal energy, wind energy, kinetic energy, solar energy, and potential energy.

In general, systems for producing electric power have three sections. First, the system taps a source of energy. Second, a power transmission system (PTS) extracts this energy so it can be sent to a generator. There are many varieties of PTS units, such as sprocket/chain, pulley/belt, and gear train systems. Third, an electric generator receives the kinetic energy from the PTS unit and converts it into electrical energy.

Some recently-developed generators harvest wave energy from the ocean. Other generators convert kinetic energy into electrical energy. Another known solution for generating electrical energy involves conversion of potential energy, which may be gravitational.

Gravitational potential energy decreases as an object falls from a higher position to a lower position relative to a gravitational field. As the force of gravity performs work on the falling object, potential energy is released. The amount of released energy is proportional to the falling object's mass, the distance it fell, and the gravitational acceleration.

Near the surface of the Earth, for example, the acceleration of gravity is a constant g=9.8 m/s². Thus, the change in gravitational potential energy for an object falling near the Earth's surface is equal to g times the object's mass and the total change in height. Various devices can convert this energy into another form so that it can be used to perform useful work elsewhere. Historically, watermills have been used to extract gravitational potential energy from falling water. In order to grind grain, as an example, the force of the water's movement would drive the blades of a wheel that, in turn, would rotate an axle driving the grist mill's other machinery. This technique for producing kinetic energy from gravitational potential energy was later used in hydroelectric plants, where falling water would turn a turbine, converting the kinetic energy of the turbine's motion into electrical energy. Most hydroelectric plants are quite large, requiring massive expenditure of money to build dams across wide rivers. However, some rural communities use micro-hydro systems as stand-alone power systems. Such systems may involve a pipe that taps a stream at the top of a hill and drops the water down a slope to power an electric generator.

However, micro-hydro systems have several known problems. Maintenance costs for the generator mechanism may become prohibitive if it is repeatedly damaged by water. The stream may flood, further damaging the system or depositing debris that blocks the intake. Alternatively, during a drought, there may not be enough water flowing in the stream to run the generator. These problems are inherent to any system that extracts gravitational potential energy from flowing water.

In remote areas, particularly in dry regions where flowing water is unavailable, there is a need for a portable generator that can provide cheap energy. Such a generator could be used, for example, in a mountainous region with steep cliffs but no surface streams. While the topography of the area would represent a large amount of potential energy, that energy could not be tapped by a micro-hydro system if no water is available.

Thus, there is a need for a way to generate electrical energy from gravitational potential energy without relying upon water. There is also a need to provide a generator that is inexpensive and can be easily transported. Such a generator could act as a stand-alone power system in a rural area without the known problems of a hydroelectric system.

### SUMMARY OF THE INVENTION

Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts are provided by the entire disclosure.

It is an object of the invention to provide a mechanically-driven electric generator that may comprise a tandem system that transforms potential energy into kinetic energy; a pulley belt system, coupled to the tandem system, that increases a rotational speed of the kinetic energy; and a gearbox system, coupled to the pulley belt system, that converts the kinetic energy having the increased rotational speed into alternating current (AC) voltage.

In various exemplary embodiments, the tandem system may comprise a primary weight; a connector, coupled to the primary weight; and an equalizing weight, coupled to the connector. The tandem system may further comprise a first pulley system coupled to the primary weight; and a second pulley system coupled to the equalizing weight.

In various exemplary embodiments, the first and second pulley systems each may comprise a fixed sub-assembly; and a movable sub-assembly. The fixed and movable sub-assemblies may each comprise a large pulley having a first diameter; a small pulley having a second diameter, wherein said second diameter is smaller than said first diameter; and a support unit that couples said large pulley to said small pulley. Alternatively, the fixed and movable sub-assemblies may each comprise a large pulley having a first diameter; a medium pulley having a second diameter, wherein said second diameter is smaller than said first diameter; a small pulley having a third diameter, wherein said third diameter is smaller than said second diameter; and a support unit that couples said large, medium, and small pulleys.

In various exemplary embodiments, the connector may link the movable sub-assembly of the first pulley system to the movable sub-assembly of the second pulley system. Alternatively, the connector may link the movable sub-assembly of the first pulley system to the movable sub-assembly of the second pulley system.

In various exemplary embodiments, the primary weight and the equalizing weight may comprise movable weight units. These movable weight units may be adjusted to make the equalizing weight heavier than the primary weight, thereby making a former equalizing weight into a new primary weight and reversing a rotary direction of the generator.

In various exemplary embodiments, the pulley belt system may comprise a drum that receives rotational energy from the tandem system; first and second driving belts that transmit the rotational energy; and a plurality of pulley units that increase rotational speed by having cascaded gear ratios. Each pulley unit may further comprise a driving pulley and a driven pulley. Rotational speed may increases in proportion to gear ratios defined by relative diameters of the driving pulley and the driven pulley. The pulley belt system may further comprise at least four of the pulley units.

In various exemplary embodiments, the pulley belt system may further comprise an idler unit that maintains tension on the second driving belt. This idler unit may further comprise a steel core encased within a Teflon™ strip; a Teflon™ disk holder; and a threaded rod.

In various exemplary embodiments, the gearbox system may comprise a gearbox unit that receives rotational energy from the pulley belt system; a generator system that converts the rotational energy into electrical energy; and a coupler that links the gearbox unit and the generator system. The gearbox system may further comprise a converter that transforms alternating current (AC) from the generator system into direct current (DC).

In various exemplary embodiments, a mechanically-driven electric generator may comprise a primary weight having a plurality of movable weight units that is lowered to release gravitational potential energy; a counterweight having a plurality of movable weight units that controls the rate of speed at which the primary weight is lowered; a plurality of tandem system pulleys that turn at a first rotational speed when the primary weight is lowered; a pulley belt system having driving and driven pulleys, coupled to the tandem system pulleys, that increase the first rotational speed to a second rotational speed in proportion to diameter ratios of the driving and driven pulleys; and a gearbox system, coupled to the pulley belt system, that converts the kinetic energy at the second rotational speed of the pulley belt system into electrical energy.

In various exemplary embodiments, a method of generating electrical energy may comprise the following steps: storing potential energy in a primary weight by raising the primary weight to a predetermined elevation; coupling the primary weight to a counterweight and a plurality of tandem pulleys; lowering the controlled weight at a speed controlled by the counterweight and turning the plurality of tandem pulleys to transform the potential energy into kinetic energy; transferring the kinetic energy from the plurality of tandem pulleys to a pulley belt system having a plurality of driving and driven pulleys; converting the kinetic energy from a lower rotational speed to a higher rotational speed in proportion to diameter ratios of the driving and driven pulleys; applying the kinetic energy at the higher rotational speed to a gearbox system; and converting the kinetic energy at the higher rotational speed into electrical energy in the gearbox system.

Advantageously, the invention provides a solution for cheap generation of electrical energy. The device requires little maintenance and may operate for long periods of time. If designed for individual needs, the device may be small enough to be stored at home and transported to other locations easily.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation that may be apparent to those skilled in the art. Accordingly, the present invention resides in the novel methods, arrangements, combinations, and improvements herein shown and described in various exemplary embodiments.

### BRIEF DESCRIPTION OF THE DRAWINGS

The invention is next described with reference to the following drawings, where like reference numerals designate corresponding parts throughout the several views.

FIG. 1a depicts an elevation view of an exemplary mechanically-driven generator;

FIG. 1b depicts an end view of an exemplary mechanically-driven generator;

FIG. 2 shows an exemplary tandem system for the generator of FIG. 1a;

FIG. 3 shows an exemplary pulley belt system for the generator of FIG. 1a;

FIG. 4a shows an elevation view of an exemplary gearbox system for the generator of FIG. 1a;

FIG. 4b shows an end view of an exemplary gearbox system for the generator of FIG. 1a;

FIG. 5 depicts another exemplary tandem system;

FIG. 6 depicts a further example of a tandem system; and

FIG. 7 shows an alternative arrangement for the idler pulley unit within the pulley belt system of FIG. 3.

### DETAILED DESCRIPTION

Referring now to the drawings, in which like numerals refer to like components or steps, there are disclosed broad aspects of various exemplary embodiments.

In various exemplary embodiments, a generator of electrical energy enables people to produce power at an affordable price with minimal maintenance for long periods of time. The device may be manufactured in different scales, ranging from small to large, depending upon individual needs. Unlike hydroelectric systems, the device does not require a constant supply of water, so it may be installed in almost any location.

The device has a number of advantages over existing generators. It does not require the use of a battery for storage of power. It can be assembled and disassembled quickly. One needs minimal training to be able to use this device. The component parts of the device, upon disassembly, can be stored in a small space, such as the trunk of a car, a closet, or a tool room. Consequently, the device can also be transported easily.

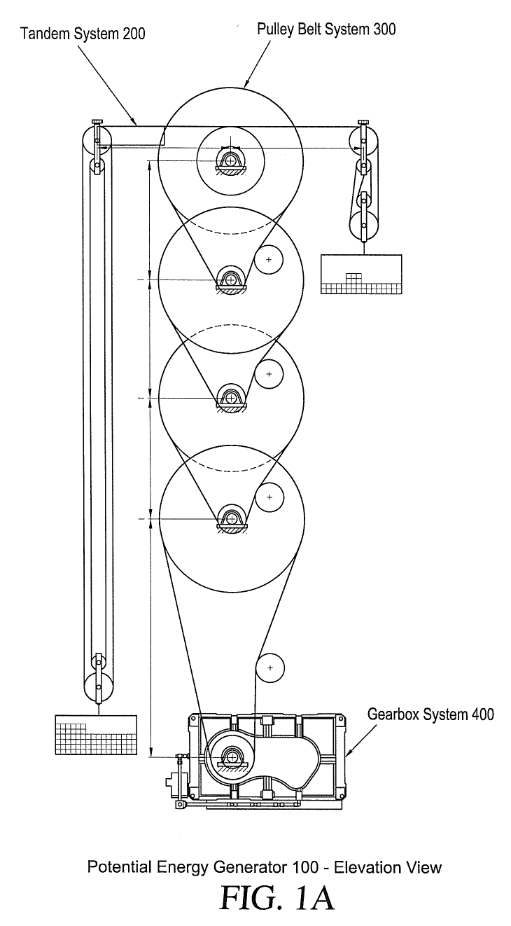

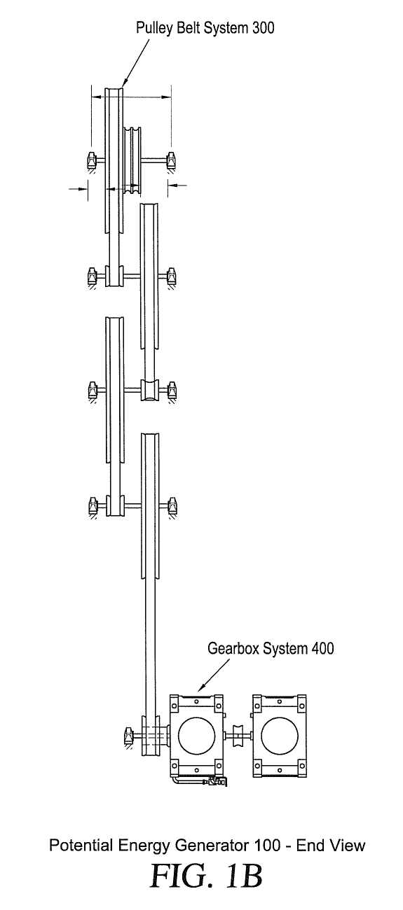

FIG. 1a depicts an elevation view of an exemplary mechanically-driven generator 100. This generator comprises three main sections, a tandem system 200, a pulley belt system 300, and a gearbox system 400, each of which will be described in detail below. Tandem system 200 converts vertical motion of weights into rotational energy. Pulley belt system 300 receives the rotational energy from tandem system 200 and increases its speed. Gearbox system 400 converts that high-speed rotational energy from pulley belt system 300 into electrical energy.

FIG. 1b depicts an end view of exemplary mechanically-driven generator 100. Tandem system 200 is not visible at this angle. As illustrated by FIG. 1b, pulley belt system 300 drives gearbox system 400. By means of cascaded gear ratios, low-speed rotation at the top of pulley belt system 300 produces high-speed rotation at the bottom of pulley belt system 300, rotation that is fast enough to generate electrical energy in gearbox system 400.

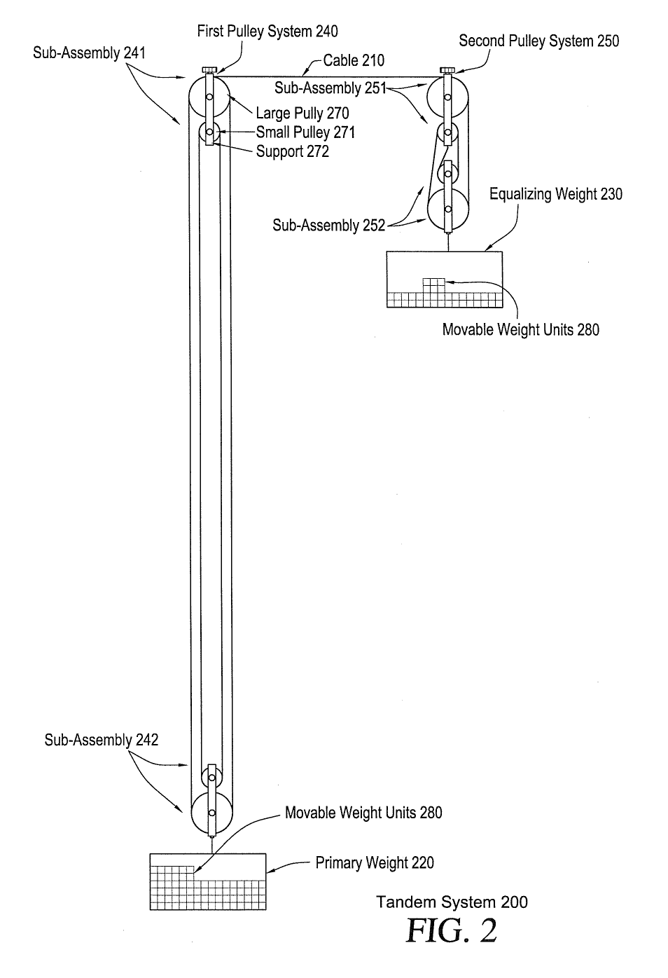

FIG. 2 shows an exemplary tandem system section 200 of electric generator 100. Tandem system 200 converts potential energy into rotational energy by using a cable 210 to couple a primary weight 220 to an equalizing weight 230. Cable 210 may be a rope or another suitable means for permitting gradual movement of primary weight 220 relative to equalizing weight 230. Tapping potential energy, cable 210 receives as input the vertical motion of primary weight 220 downward relative to equalizing weight 230. In response, cable 210 rotates a first pulley system 240, coupled to primary weight 220, and a second pulley system 250, coupled to equalizing weight 230. In this way, the potential energy released by the relative movement of primary weight 220 with respect to equalizing weight 230 is transformed into rotational energy.

First pulley system 240 comprises a first sub-assembly 241 and a second sub-assembly 242. In a similar manner, second pulley system 250 comprises a third sub-assembly 251 and a fourth sub-assembly 252. First sub-assembly 241 and the third sub-assembly 251 may be fixed to the top of tandem system 200, while second sub-assembly 242 and fourth sub-assembly 252 move up and down in accordance with the relative motions of primary weight 220 and equalizing weight 230. The difference in weight between primary weight 220 and equalizing weight 230 should be selected to determine the rate of descent of primary weight 220, ensuring that primary weight 220 drops at a controlled rate of speed. The speed should be slow enough to reduce the risk of injury to a person who is operating generator 100.

Each sub-assembly 241, 242, 251, and 252 in tandem system 200 may comprise three units: a large pulley 270, a small pulley 271, and a support unit 272. Fixed sub-assemblies 241 and 251 have large pulleys 270 on top while movable sub-assemblies 242 and 252 have small pulleys 271 on top. Large pulleys 270 and small pulley 271 may be rotating drums or wheels with curved convex rims that may be mounted on a hook or base for stability. A rope, belt, chain, or other suitable means may move along the drum's rim to change the direction of motion of large pulley 270 or small pulley 271. The drum may be grooved to ensure that the rope cannot slip off.

For tandem system 200, applicable weight values for primary weight 220 and equalizing weight 230 may be selected to produce a desired amount of rotational energy in pulley systems 240 and 250. For example, primary weight 220 may be 500 kg while equalizing weight 230 may be 400 kg. The total length of cable 210, coupling primary weight 220 to equalizing weight 230, may be about 15 meters. As will be apparent to those of skill in the art, other weights and lengths may be used, depending upon the amount of energy that is needed and the physical location where generator 100 is installed.

Movable weight units 280 may be added to either primary weight 220 or equalizing weight 230. In this way, the motion of the device may be reversed. Once enough movable weight units 280 are added to equalizing weight 230 so that it outweighs primary weight 220, equalizing weight 230 may function as a new primary weight 220. After the weight-loading process is finished, tandem system 200 may operate again, causing pulley systems 240 and 250 to rotate backwards relative to the previous cycle.

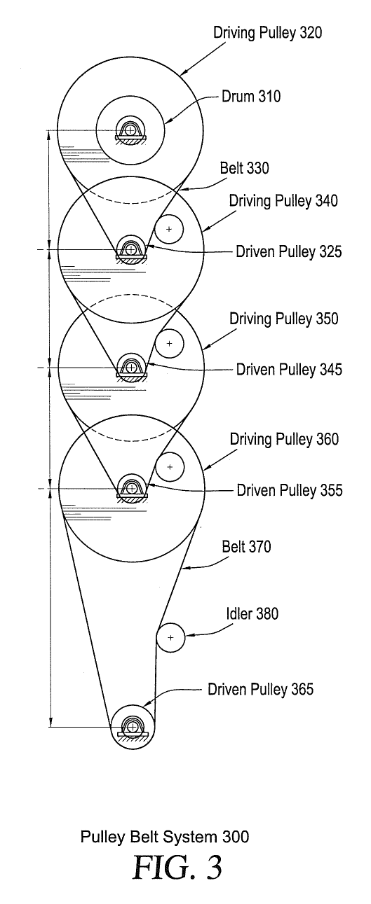

FIG. 3 depicts an exemplary pulley belt system section 300 of the electric generator 100.

Pulley belt system 300 may act as a PTS unit, transmitting rotational energy generated by tandem system 200. Drum 310 may receive torque and speed from cable 210 and send this rotational energy into a first pulley 320. Cable 210 may be wrapped, for example, one turn around drum 310.

The addition of movable weight units 280 to primary weight 220 so that primary weight 220 is significantly heavier than equalizing weight 230 may cause primary weight 220 to drop a vertical distance that may be about two meters or another appropriate distance. This vertical motion may produce rotation in drum 310 at a speed that is proportional to the number of pulleys within tandem system 200.

A first belt 330 transfers rotational energy sent from drum 310 to first pulley 320 into second pulley 325. In one embodiment, pulley belt system 300 may have a cascaded sequence of eight pulleys 320, 325, 340, 345, 350, 355, 360, and 365 arranged so that the following pairs of pulleys constitute pulley units (320, 325); (340, 345); (350, 355); (360, 365). For each pulley unit, the first pulley in the sequence has a larger diameter and drives the second sequence. Thus, pulleys 320, 340, 350, and 360 are driving pulleys while pulleys 325, 345, 355, and 365 are driven pulleys.

This arrangement may allow the rotational speed to steadily increase in proportion to the relative sizes of the driving and driven pulleys, a parameter that may be called a gear ratio. The gear ratio may be defined as the diameter ratio between driving pulleys 320, 340, 350, and 360 and driven pulleys 325, 345, 355, and 365. Because the driving pulleys 320, 340, 350, and 360 have larger diameters than driven pulleys 325, 345, 355, and 365, the rotational speed of driven pulleys 325, 345, 355, and 365 may be proportionally faster than the rotational speed of driving pulley 320, 340, 350, and 360. These ratios may be inversely proportional to the ratios of the respective speeds of the driving pulleys 320, 340, 350, and 360 and driven pulleys 325, 345, 355, and 365. This speed may be somewhat slower than the actual ratio due to friction.

The final pulley unit 365 may rotate at a sufficient speed for generation of electrical energy. For this purpose, a second belt 370 may be coupled to pulley unit 365 to extract its rotational energy. An idler unit 380 may be coupled to second belt 370 to provide additional tension.

The use of eight pulleys 320, 325, 340, 345, 350, 355, 360, and 365 is merely exemplary, as the actual design of pulley belt system 300 will depend upon the desired rotational speed of pulley unit 365 and the gear ratios of the pulleys 320, 325, 340, 345, 350, 355, 360, and 365.

First belt 330 may be approximately three meters in length. Second belt 370 may be approximately four meters in length. The length of both first belt 330 and second belt 370 may be varied depending upon the size of pulley units 320, 325, 340, 345, 350, 355, 360, and 365.

The eighth pulley 365 may be moving at a speed fast enough that electric power can be efficiently generated. To produce such a high speed, the gear ratios between the first pair of pulleys 320, 325, the second pair of pulleys 340, 345; the third pair of pulleys 350, 355; and the fourth pair of pulleys 360, 365 may be approximately 10:1. Alternatively, smaller gear ratios may be used, producing a significantly slower rotational speed to prevent the large wheels from rotating at dangerous speeds.

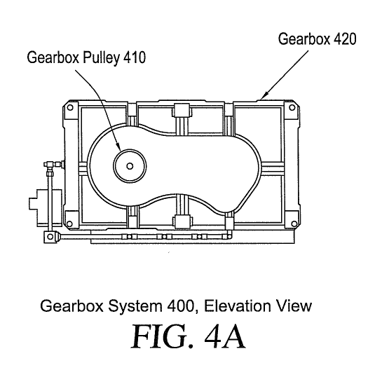

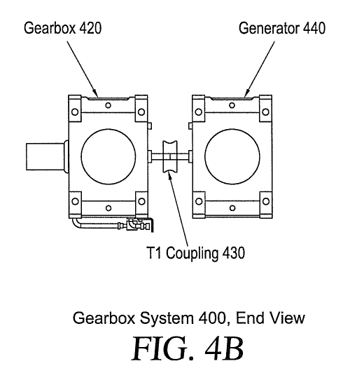

FIG. 4a shows an elevation view of an exemplary gearbox system 400 for generator 100.

As shown in FIG. 4a, gearbox system 400 may comprise a gearbox pulley 410 coupled to the second driving belt 370 of pulley belt system 300 that receives rotational energy from the last pulley unit 365 in pulley belt system 300. Idler unit 380 may provide tension to maintain second belt 370 in contact with gearbox pulley 410 and ensure that second belt 370 remains mounted.

FIG. 4b shows an end view of an exemplary gearbox system 400 for generator 100.

As shown in FIG. 4b, the rapid motion of gearbox pulley 410 drives gearbox 420, thereby sending energy into T1 grid coupling 430. Coupling 430 powers generator system 440, the final stage of gearbox system 400. An AC/DC converter may transform alternating current (AC) from generator system 440 into direct current (DC).

Gearbox 420 may itself include internal parts (not shown) that further increase the rotational speed transmitted through coupling 430 to generator system 440. By reducing the torque needed to drive gearbox system 400, the use of gear ratios to increase rotational speed within gearbox 420 may permit generator 100 to get a longer run out of each weight-drop. If a prefabricated gearbox is used, gearbox 420 may have a rotational speed of 5000 rotations per minute (rpm) at ¼ horsepower. As will be apparent to one of ordinary skill in the art, other rotational speed and power values may also be used.

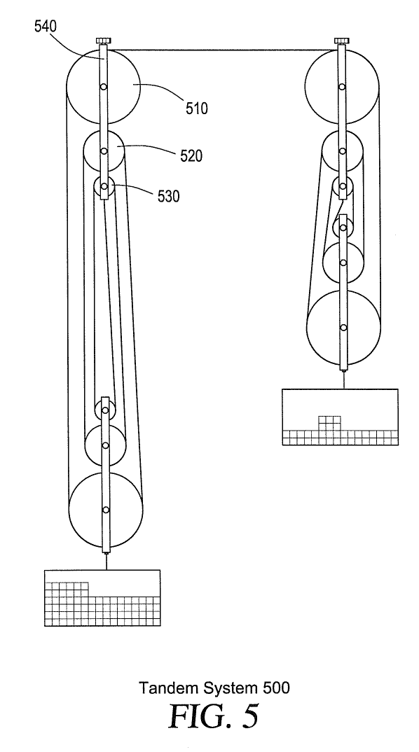

FIG. 5 depicts another exemplary tandem system 500 for generator 100.

Tandem system 500 differs from tandem system 200, previously described with reference to FIG. 2, by having four units for each sub-assembly 241, 242, 251, and 252. While each sub-assembly 241, 242, 251, and 252 in tandem system 200 comprised three units: a large pulley 270, a small pulley 271, and a support unit 272, each sub-assembly 241, 242, 251, and 252 in tandem system 500 has a large pulley 510, a medium pulley 520, a small pulley 530, and a support unit 540. Fixed sub-assemblies 241 and 251 have large pulleys 510 on top while movable sub-assemblies 242 and 252 have small pulleys 530 on top.

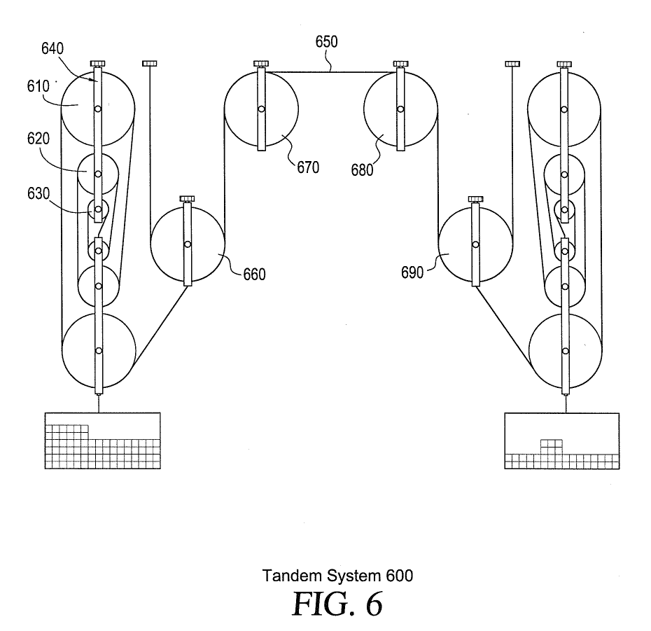

FIG. 6 depicts a further example of a tandem system 600 for a generator 100.

Like FIG. 5, each sub-assembly 241, 242, 251, and 252 in tandem system 600 has a large pulley 610, a medium pulley 620, a small pulley 630, and a support unit 640. However, fixed sub-assembly 241 is not coupled by cable 242 to fixed sub-assembly 251. Instead, tandem system 600 uses a second cable 650 to couple four pulley units 660, 670, 680, and 690 between movable sub-assembly 242 and movable sub-assembly 252.

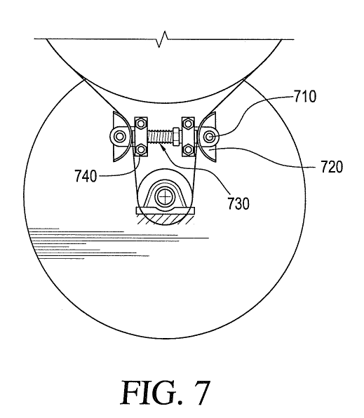

FIG. 7 shows an alternative arrangement 700 for idler unit 380 within pulley belt system 300 of FIG. 3.

In order to increase the efficiency of the overall system, arrangement 700 may achieve an optimal traction force between the last pulley unit 365 and second belt 370. This arrangement comprises a steel core 710 encased within al Teflon™ strip 720, a threaded rod 730, and a Teflon™ disk holder 740. It may be important to control frictional forces, as the efficiency of the system may be reduced if sliding friction slows the movement of the pulley belt system 300.

From the above description, it will be apparent that the invention disclosed herein provides a novel and advantageous system and method for generation of electrical energy. The foregoing discussion discloses and describes merely exemplary methods and embodiments of the present invention. One skilled in the art will readily recognize from such discussion that various changes, modifications and variations may be made therein without departing from the spirit and scope of the invention. Accordingly, disclosure of the present invention is intended to be illustrative, but not limiting, of the scope of the invention, which is set forth in the following claims.

We claim:

1. A mechanically-driven electric generator comprising:
a tandem system that transforms potential energy into kinetic energy;
a pulley belt system coupled to said tandem system, the pulley belt system increasing a rotational speed of said kinetic energy; and
a gearbox system coupled to said pulley belt system, the gearbox system converting said kinetic energy having said increased rotational speed into alternating current (AC) voltage.

2. The generator of claim 1, said tandem system comprising:
a primary weight;
a connector coupled to said primary weight; and
an equalizing weight coupled to said connector.

3. The generator of claim 2, said tandem system further comprising:
a first pulley system coupled to said primary weight; and
a second pulley system coupled to said equalizing weight.

4. The generator of claim 2, said first and second pulley systems each comprising:
a fixed sub-assembly; and
a movable sub-assembly coupled to said fixed sub-assembly.

5. The generator of claim 4, said fixed and movable sub-assemblies each comprising:
a large pulley having a first diameter;
a small pulley having a second diameter, wherein said second diameter is smaller than said first diameter; and
a support unit that couples said large pulley to said small pulley.

6. The generator of claim 4, said fixed and movable sub-assemblies each comprising:
a large pulley having a first diameter;
a medium pulley having a second diameter, wherein said second diameter is smaller than said first diameter;
a small pulley having a third diameter, wherein said third diameter is smaller than said second diameter; and
a support unit that couples said large, medium, and small pulleys.

7. The generator of claim 4, said connector linking said fixed sub-assembly of said first pulley system to said fixed sub-assembly of said second pulley system.

8. The generator of claim 4, said connector linking said movable sub-assembly of said first pulley system to said movable sub-assembly of said second pulley system.

9. The generator of claim 2, wherein said primary weight and said equalizing weight further comprise movable weight units.

10. The generator of claim 10, wherein, when said movable weight units are adjusted to make said equalizing weight heavier than said primary weight, a former equalizing weight become a new primary weight and reverses a rotary direction of said generator.

11. The generator of claim 1, said pulley belt system comprising:
a drum that receives rotational energy from said tandem system;
first and second driving belts that transmit said rotational energy; and
a plurality of pulley units that increase rotational speed by having cascaded gear ratios.

12. The generator of claim 11, each pulley unit further comprising:
a driving pulley having a first diameter; and
a driven pulley having a second diameter, wherein said second diameter is smaller than said first diameter.

13. The generator of claim 12, wherein rotational speed increases in proportion to a gear ratio defined by a proportion of said first diameter of said driving pulley and said second diameter of said driven pulley.

14. The generator of claim 11, said pulley belt system further comprising at least four of said pulley units.

15. The generator of claim 11, said pulley belt system further comprising;
an idler pulley unit that maintains tension on said second driving belt.

16. The generator of claim 15, said idler pulley unit further comprising:
a steel core encased within a Teflon™ strip;
a Teflon™ disk holder; and
a threaded rod.

17. The generator of claim 1, said gearbox system further comprising:
a gearbox unit that receives rotational energy from said pulley belt system;
a generator system that converts said rotational energy into electrical energy; and
a coupler that links said gearbox unit and said generator system.

18. The generator of claim 17, said gearbox system further comprising:
a converter that transforms alternating current (AC) from said generator system into direct current (DC).

19. A mechanically-driven electric generator comprising:
a primary weight that is lowered to release gravitational potential energy, the primary weight comprising a plurality of movable weight units;
a counterweight that controls the rate of speed at which said primary weight is lowered, the counterweight comprising a plurality of movable weight units;
a plurality of tandem system pulleys that turn at a first rotational speed when said primary weight is lowered;
a pulley belt system having driving and driven pulleys, coupled to said tandem system pulleys, that increase said first rotational speed to a second rotational speed in proportion to diameter ratios of said driving and driven pulleys; and
a gearbox system, coupled to said pulley belt system, that converts kinetic energy at said second rotational speed of said pulley belt system into electrical energy.

20. A method of generating electrical energy comprising the following steps:
storing potential energy in a primary weight by raising said primary weight to a predetermined elevation;
coupling said primary weight to a counterweight and a plurality of tandem pulleys;
lowering said controlled weight at a speed controlled by said counterweight and turning said plurality of tandem pulleys to transform said potential energy into kinetic energy;
transferring said kinetic energy from said plurality of tandem pulleys to a pulley belt system having a plurality of driving and driven pulleys;
converting said kinetic energy from a lower rotational speed to a higher rotational speed in proportion to diameter ratios of said driving and driven pulleys;
applying said kinetic energy at said higher rotational speed to a gearbox system; and
converting said kinetic energy at said higher rotational speed into electrical energy in said gearbox system.
